(19) United States
(12) Patent Application Publication
(10) Pub. No.: US 2022/0391850 A1
(43) Pub. Date: Dec. 8, 2022

(54) System and Method for Creating and Trading Cryptographically Secured Digital Employability Assets

(71) Applicant: kitabu wazi, Inc., San Antonio, TX (US)

(72) Inventor: Victor Morris, London (GB)

(21) Appl. No.: 17/831,179

(22) Filed: Jun. 2, 2022

Related U.S. Application Data
(60) Provisional application No. 63/258,865, filed on Jun. 4, 2021.

(51) Int. Cl. G06Q 10/10; H04L 9/00

(52) U.S. Cl. CPC G06Q 10/1053; H04L 9/50

(57) ABSTRACT

A method for generating a digital employability token, comprising obtaining user data associated with one or more employability intelligence indicators associated with a user; generating a digital user profile record based on analysis of the user data using machine learning model. The digital user profile record comprises assessment data and summary data that are indicative of user employability. The method further comprises generating an immutable digital employability token based on the digital user profile record, wherein the digital employability token is associated with a unique digital identity identifier; and outputting the digital employability token for use by the user based on a minting process.

### CROSS-REFERENCE TO RELATED APPLICATION

This application claims priority from U.S. Provisional Application No. 63/258,865 filed Jun. 4, 2021, the content of which is incorporated herein.

### TECHNICAL FIELD

This present disclosure generally relates to a blockchain network, and more particularly to a blockchain-based employability and talent intelligence platform.

### BACKGROUND

Existing talent acquisition systems are insufficient for the “Great Resignation”, youth unemployment, and future of work because they 1) rely on unverified job descriptions and candidate info, 2) use negative filters and 3) weakly filter organizational fit and purpose. Currently, both graduates/job seekers and employers are unable to mutually qualify and quantify employability as well as labor market attractiveness because both parties are unsure about skill levels and organizational fit which is resulting in large-scale quitting in the United States along with high unemployment and underemployment rates in many parts of the world such as Africa. For example, 48 million Americans quit their jobs in 2021 resulting in large-scale job openings and $1.2 trillion cost to businesses. The rising rates of unemployment among the youth, especially university graduates, are also alarming.

Simply having employability assets such as employer-relevant knowledge, skills, abilities, and attitudes is insufficient for the jobseekers to advance self-sufficiently in the current labor market or realize their potential. The jobseekers must also be able to utilize their employability assets, advertise and sell them in a marketplace with lower barriers to entry in different professional fields.

The employer also faces complex challenges while assessing candidate skills and labor market relevance. For example, asymmetric information about candidate employability competencies and labor market relevance can make employers less willing to consider the candidate for roles. Thus, the graduates end up being unemployed or underemployed.

Moreover, the existing talent acquisition systems may be expensive and incompatible with future of work.

Therefore, there is a need for a system and a method that enables the jobseekers to maintain and market their employability assets in the labor market globally, where the employability assets enable the employers to easily shortlist, interview, and hire candidates from the labor market for the required job role.

### BRIEF SUMMARY OF SOME EXAMPLE EMBODIMENTS

According to the present disclosure, it is an objective of the present disclosure to provide a system that enables the jobseekers to generate digital employability assets (also referred to as “talent portfolios”) and share their verified employability assets in a digital labor marketplace to seek job opportunities.

Some embodiments are based on the realization that by putting jobseekers in control of their data comprising their validated pedagogical knowledge and skills would allow the jobseekers to directly engage the employers in relevant labor market sectors. It would also enable secure labor market data sharing for employment purposes without compromising privacy. Pedagogical knowledge and skills data and insights are personal assets that the jobseekers should control, increase, and benefit from.

To that end, the present disclosure proposes to generate a peer-to-peer electronic labor market (also referred to as “digital labor marketplace”) that allows willing parties (jobseekers/employers) to directly exchange employability assets and entitlements with more certainty and without going through fragmented third-party intermediaries such as consulting agencies and the like. The peer-to-peer electronic labor market is based on a blockchain based network that provides efficient state verifications of employability assets and entitlements associated with the jobseekers along with real-world economic incentives like employer asset investment in the form of hiring.

In the digital labor marketplace, both the parties (i.e., jobseekers and employers) jointly invest in shared employability attributes and requirements as well as work readiness assessments while reducing barriers to the labor market entry.

To that end, the present disclosure proposes an architecture comprising an integrated system that generates immutable digital employability token based on digital employability assets, where the digital employability token may be traded in the digital labor marketplace directly by the user along with cryptographic proof. The cryptographic proofing of the digital employability asset avoids human ambiguity and bias in the digital labor marketplace. The integrated system ensures that both the parties are mutually able to qualify and quantify employability as well as labor market attractiveness because of higher verified skill levels and labor market relevance certainty.

Accordingly, in one aspect, a computing system for generating the digital employability token is provided. The computing system comprises at least one processor and a memory having stored thereon computer-executable instructions that are structured such that, when executed by the at least one processor, cause the computing system to: obtain user data associated with one or more employability intelligence (EI) (also referred to as “talent intelligence and TALINT”) indicators associated with a user, generate a digital user profile record based on analysis of the user data using a machine learning (ML) model. The digital user profile record comprises assessment data, and summary data, indicative of user employability potential. The computing system is further configured to generate an immutable digital employability token based on the digital user profile record, where the digital employability token is associated with a unique digital identity identifier; and output the digital employability token for use by the user based on a minting process.

In some embodiments, the digital employability token is a non-fungible token (NFT) associated with a digital authentication certificate.

In some embodiments, the computing system comprises the NFT, which is used for trading in a digital labor marketplace, where the digital labor marketplace comprises a blockchain network based digital labor marketplace.

In some embodiments, the trading comprises execution of a smart contract for an exchange of the NFT between the user and a second user.

In some embodiments, the user is one or more of: a graduate, a job seeker, a student, and an employer.

In some embodiments, the digital user profile record comprises: a snapshot of the assessment data, and the summary data, where the assessment data and the summary data are visualized on one or more dashboards.

In some embodiments, the computing system comprises the one or more dashboards that comprise a visual interface displaying one or more of: higher education outcomes indicators, competencies indicators, employability indicators, world economic forum (WEF) employability skills, skills indicators across different types, job functions predictions, overall employability indicators score, academic qualification data, work exposure data, professional maturity references data, psychometric test results data, profile snapshot, competency requirements, skills requirements, internship experience, top roles, top job functions and desired employability indicators range.

In one aspect, a method for generating a digital employability token is provided. The method comprising: obtaining user data associated with one or more employability intelligence (EI) indicators associated with a user; generating a digital user profile record based on analysis of the user data using a machine learning (ML) model. The digital user profile record comprises assessment data and summary data, the assessment data and the summary data together being indicative of user employability potential. The method further comprises generating an immutable digital employability token based on the digital user profile record, where the digital employability token is associated with a unique digital identity identifier; and outputting the digital employability token for use by the user based on a minting process.

In another aspect, the computer program product for generating a digital employability token is provided. The computer program product comprises the digital user profile record comprises: a snapshot of the assessment data and the summary data, wherein the assessment data and the summary data is visualized on one or more dashboard, wherein the one or more dashboards comprise a visual interface displaying one or more of: higher education outcomes indicators, competencies indicators, employability indicators, world economic forum (WEF) employability skills, skills indicators across different types, job functions predictions, overall employability indicators score, academic qualification data, work exposure data, professional maturity references data, psychometric test results data, profile snapshot, competency requirements, skills requirements, internship experience, top roles, top job functions and desired employability indicators ranges.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1A illustrates a block diagram showing a network environment of a computing system for generating digital employability assets, in accordance with one or more example embodiments;

FIG. 1B illustrates components of the market-based labor platform, in accordance with one or more example embodiments;

FIG. 1C illustrates a high-level system diagram of the computing system, according to one or more example embodiments;

FIG. 2 illustrates a high-level flow diagram of the computing system, in accordance with one or more example embodiments;

FIG. 3A illustrates an employability dashboard comprising a plurality of employability snapshots of a plurality of users, in accordance with one or more example embodiments;

FIG. 3B illustrates steps of a method for generating a dynamic resume for a jobseeker, in accordance with one or more example embodiments;

FIG. 3C illustrates an employer dashboard comprising an employer snapshot, in accordance with one or more example embodiments;

FIG. 4 illustrates a block diagram of a blockchain platform that is executed in the computing system of FIG. 1, in accordance with one or more example embodiments;

FIG. 5 illustrates a detailed flow diagram of a method executed by the computing system for generating a digital employability token, in accordance with one or more example embodiments;

FIG. 6 illustrates a high-level block diagram of processes utilized for generating a digital employability token, in accordance with one or more example embodiments;

FIG. 7 illustrates a high-level business process diagram associated with a blockchain platform that is executed in the computing system of FIG. 1, in accordance with one or more example embodiments;

FIG. 8 illustrates a block diagram of the user equipment for accessing the services of the decentralized market-based labor platform, in accordance with one or more example embodiments; and

FIG. 9 illustrates steps of a method for generating a digital employability token, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for generating a digital employability token, where the digital employability token can be traded in a blockchain based digital labor marketplace. The proposed system enables both the jobseekers and the employers to qualify and quantify employability as well as labor market attractiveness by providing higher verified skill levels and labor market relevance certainty. To that end, initially data associated with a user is obtained, where the user comprises the jobseekers and the employers. For example, the system is configured to obtain data associated with the employability intelligence (EI) of the jobseeker, where the data may comprise pedagogical data, professional maturity data, skills data, and the like. The EI estimates the employability potential and professional maturity of the jobseeker. Based on the obtained data the system is further configured to generate a digital user profile. The digital user profile is configured to comprise and display employability intelligence (EI) indicators corresponding to different employability assets of the jobseeker. The EI indicator is an estimate of graduate knowledge and skills as well as abilities and attitudes (competencies) determined based on the obtained data of the job seeker.

The system is further configured to verify the digital user profile by minting the digital user profile to generate the digital employability token. The digital employability token is associated with a digital authentication certificate that certifies the digital user profile and underlying employability assets of the user. The digital employability token can then be traded by the jobseeker with one or more employers in the digital labor marketplace to seek multiple job opportunities. Further, the one or more employers are also assured about the authentication of the jobseeker based on the digital employability token.

These and various other advantages of the systems and methods disclosed herein will be apparent from the detailed description provided herein, in conjunction with the various accompanying figures described below.

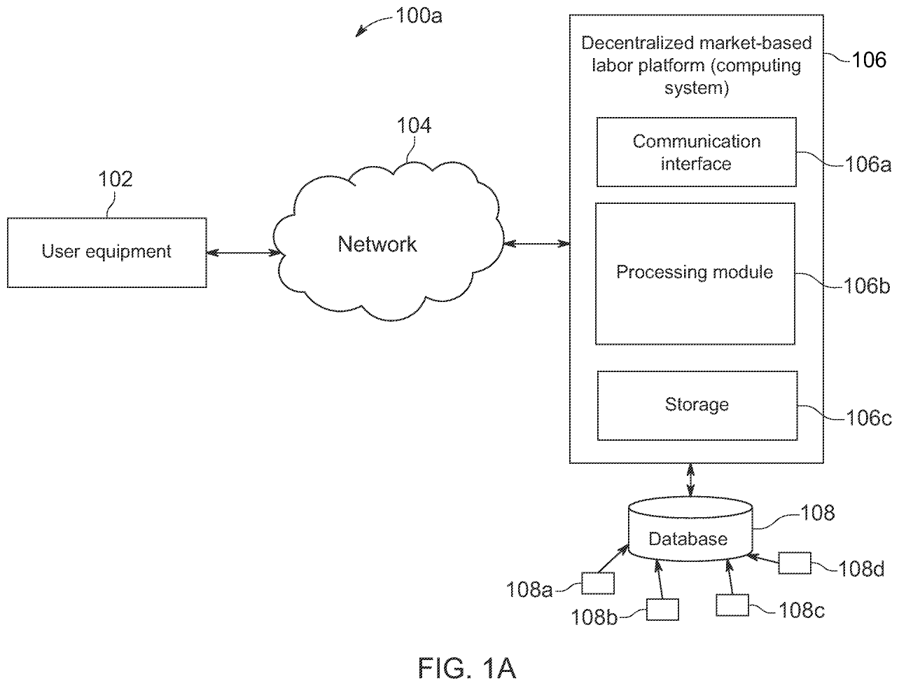

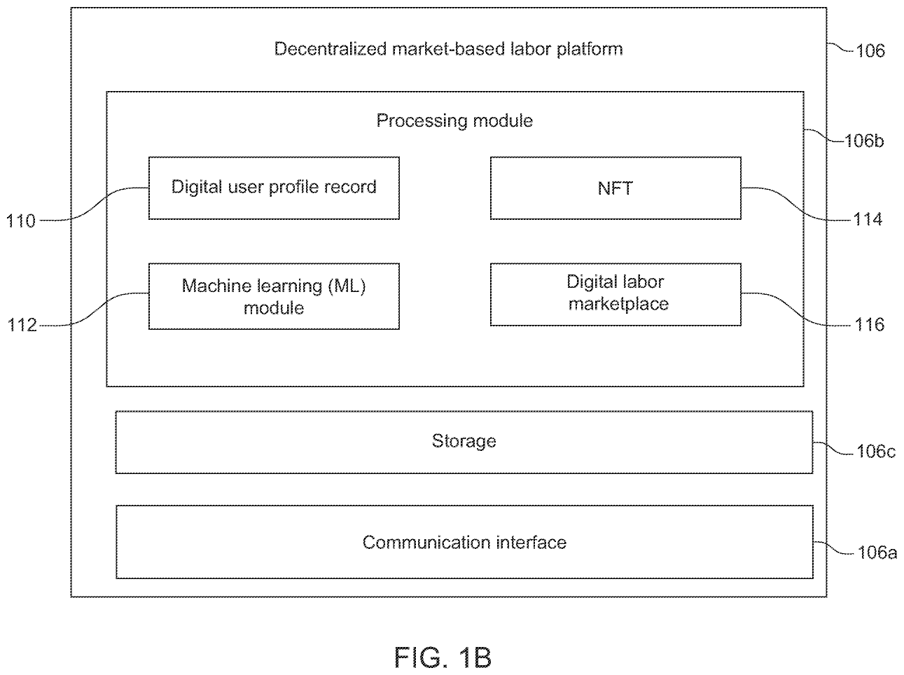

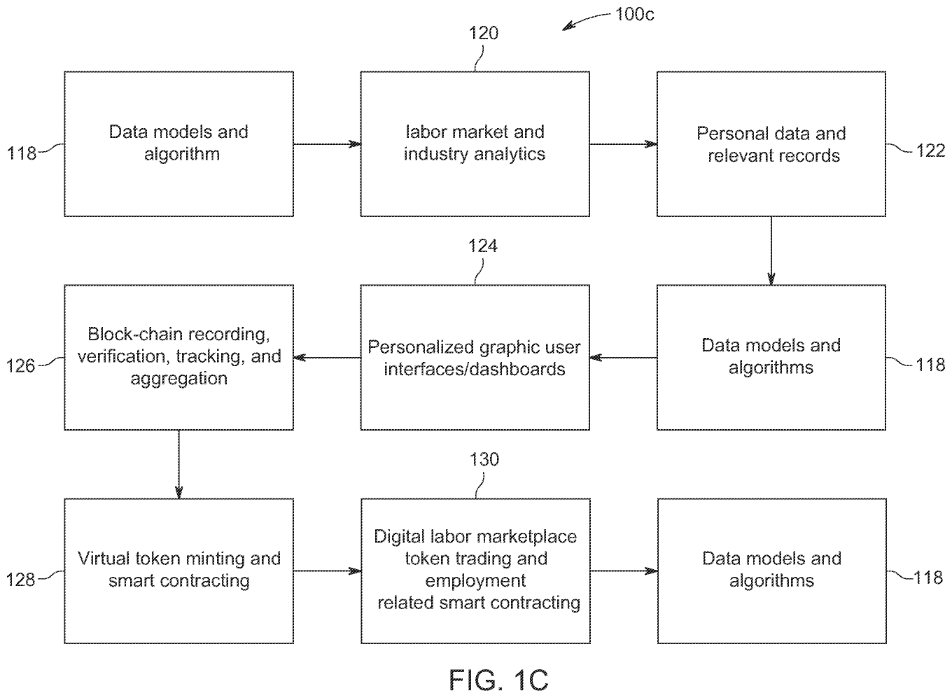

FIG. 1A illustrates a block diagram showing a network environment 100a of a computing system 106 for generating digital employability assets, in accordance with one or more example embodiments. The network environment 100a comprises a user equipment 102 in communication with a decentralized market-based labor platform (also referred to as “computing system”) 106 over a communication network 104, where the user equipment 102 may comprise user devices such as smartphones, smartwatches, laptops, computers, and the like. The decentralized market-based labor platform 106 may be hosted by one or more servers. The decentralized market-based labor platform 106 may also be associated with an external database 108, which may store data about a plurality of user profiles of users 108a or recruiters 108b or jobs 108c or companies 108d. In some embodiments, the plurality of user profiles may be associated with talent acquisition data for a customer of the digital employability assets on the decentralized market-based labor platform 106.

Further, a user associated with a user profile of the plurality of user profiles may be a jobseeker such as a graduate or a student actively looking for a job, an employee of an organization, a freelancer, and the likes. The user is required to register itself on the decentralized market-based labor platform 106 to access the decentralized market-based labor platform (also referred to as “labor market”) 106, where the user may publish its digital employability assets. The digital employability assets of the user comprise employer-relevant knowledge, skills, and attitudes. On registration, the decentralized labor market platform 106 creates a digital user profile (for example, the user profiles 108a and 108b) associated with the registered user. In an embodiment, the jobseeker may be for example, less than 41 years of age.

The digital user profile includes information associated with the user. The digital user profile is organized in the form of multiple fields which give information about the user. The multiple fields may include name, age, gender, qualifications, experience, nationality, contact details, public profile link, website link, skills information, and the like, where the information associated with the user is submitted by the user itself, for example, the user may be asked to enter its information during the registration process. A plurality of such user profiles associated with corresponding plurality of users is generated based on information provided by the plurality of users. The plurality of user profiles are stored in the database 108.

The decentralized market-based labor platform 106 may be embodied as a system for generating digital user profiles (for example, user profiles 108a-108d) records associated with profiles stored in the database 108, where the digital user profiles are used to generate the digital employability assets of the user. In some embodiment, the decentralized market-based labor platform 106 is embodied as a decentralized application such as block chain for generating the digital employability assets of the user.

The decentralized market-based labor platform 106 comprises one or more communication interfaces 106a for exchanging data with the user equipment 102 and the database 108, and also other entities external to the digital employability assets on the decentralized market-based labor platform 106. The one or more communication interfaces 106a include at least an input interface and an output interface. The input interface may be configured to receive input data associated with the user, for example profile data of the user required to generate the user profiles.

The input profile data may be received from one or more sources such as from the user, from a public forum, from a social networking portal, from a professional networking portal, from an email account, from direct submission by the user on the decentralized market-based labor platform 106, from a web crawler that crawls public profiles on the web, and the like. In some embodiments, the input profile is related to datasets of the user generated by the digital employability assets on the decentralized market-based labor platform 106 for graduates/job seekers/students and employer trading in a P2P labor on-chain marketplace. In that sense, the input profile is the user profile, or the employer profile of a job opportunity related to the user and employer.

The data of input profile may be received in any of a number of possible formats, such as, in the form of a resume document, a job description related submission document, a form submitted on a job portal or website, a direct submission entry made on the digital employability assets on the decentralized market-based labor platform and the like. For example, a user may access their user equipment 102 and use that to open or browse to a web page that may be the landing page for a website hosted by the digital employability assets on the decentralized market-based labor platform 106. Then, the user selects an option for entering an input profile and its data, on the web page, and a form having different fields requiring user input may open up. These different fields may be configured for gathering information about the data, and may include fields such as name, years of experience, gender, technical skills, age, past organization, assessment result, current designation/role, and the like. In some embodiments, the user may directly enter or upload a resume as the input profile data.

The decentralized market-based labor platform 106 further comprises a processing module 106b or a processor, which is configured to execute one or more computer executable instructions related to management of data by the decentralized market-based labor platform 106. The computer-executable instructions may be stored in a storage 106c, or a memory associated with the digital employability assets on the decentralized market-based labor platform 106. The storage 106c also stores a rule-based model and a trained ML model in the form of computer-executable instructions specific to implementation of the rule-based model and the trained ML model respectively, when required. In addition, the storage 106c may also store a training dataset of profile data that is derived from the plurality of user profiles (or just profiles) stored in the database 108, and a test dataset of profiles stored in the database 108. The storage 106c also stores a plurality of rules in the form of computer-executable instructions for checking a plurality of conditions associated with the rule-based model. Thus, using the embodiments described above, the digital employability assets on the decentralized market-based labor platform 106 embodies the system for managing data, specifically user data for user data profiles stored in the database 108.

In some embodiments, the rule-based model and the trained ML model may be stored in a cloud computing-based server, a remote server, or a virtual server that may be different from but is associated with the decentralized market-based labor platform 106.

Further, the user equipment 102, the decentralized market-based labor platform 106, and the database 108, are all coupled communicatively via the communication network 104.

The communication network 104 may be wired, wireless, or any combination of wired and wireless communication networks, such as cellular, Wi-Fi, internet, local area networks, or the like. In one embodiment, the communication network 104 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. The communication network 104 communicatively couples the user equipment 102 used by the customer for accessing the services provided by the digital employability assets on the decentralized market-based labor platform 106.

In some embodiments, the digital employability assets on the decentralized market-based labor platform 106 is configured to extract and store various profiles in the database 108, such as user profiles, profiles from organizations' Application Tracking System (ATS), profiles crawled from the internet, and the like.

In some embodiments, the user equipment 102 and the computing system 106 may be embodied together as a single entity.

FIG. 1B illustrates components of the decentralized market-based labor platform 106, in accordance with one or more example embodiments. FIG. 1B is described below in conjunction with FIG. 1A. The decentralized market-based labor platform 106 comprises a machine learning (ML) module 112, a digital user profile record 110, a non-fungible token (NFT) 114, and a digital labor marketplace module 116. The ML module 112 is configured to obtain input profile data associated with employability intelligence of the user and analyze the input profile data based on employability intelligence indicators, where the employability intelligence is an estimate of jobseeker's (for example, a graduate) employability potential and professional maturity. Thus, the employability intelligence (EI) provides a perspective to fuse and analyze all relevant sources of information (i.e., internal source of information and external source of information) and intelligence of the jobseeker to produce running intelligence estimates of the jobseeker's employability potential and labor market relevance. For example, a graduate's higher education learning outcomes, skills (e.g., hard, soft, and digital), and emotional intelligence are internal sources. External sources include, but are not limited to, employer-valued skills and labor market trends data from primary and secondary sources. The employability intelligence of the jobseeker may be used to generate employability intelligence (EI) report (EIR) that comprises visualizations, assessments, and summaries of jobseeker's employability potential and competencies. Similarly, the employability intelligence is used to generate an employability intelligence indicator indicative of all-source estimates of graduate knowledge and skills as well as abilities and attitudes (competencies).

The ML module 112 is further configured to embed the input profile data into digital employability assets of the user associated with the input profile data on the decentralized market-based labor platform 106, where the digital employability assets of the user are comprised in the digital user profile record 110. The digital user profile record 110 further includes the EIR that comprises a snapshot of the assessment data, and the summary data associated with jobseeker's employability potential and competencies. The assessment data and the summary data are visualized on one or more dashboards. The one or more dashboards comprise a visual interface displaying one or more of: higher education outcomes indicators, competencies indicators, employability indicators, world economic forum (WEF) employability skills, skills indicators across different types, job functions predictions, overall employability indicators score, academic qualification data, work exposure data, professional maturity references data, psychometric test results data, profile snapshot, competency requirements, skills requirements, internship experience, top roles, top job functions, desired employability indicators range, and the like.

Once the digital user profile record 110 is created, the digital user profile is minted into NFT 114 by using a block chain technology, where the minting associates the NFT 114 with a unique digital identity identifier of the user that may acts as a digital authentication certificate for the user. The NFT 114 is an immutable digital employability token, of the user, generated based on the digital user profile record. After minting, the NFT 114 enables trading of the digital employability assets using the digital labor marketplace module 116, where trading of the digital employability assets comprises exchanging the digital employability assets between the jobseeker (graduate/students) and employers, by execution of a smart contract for an exchange of the NFT 114 between the jobseekers and the employer. Using the smart contracts, participants (i.e., jobseekers and employers) can market and redeem as well as mutually invest in the digital employability assets followed by traditional recruitment and hiring procedures. Further, the participants can reduce the uncertainty associated with job seeker employability potential and labor market relevance because the value of each NFT 114 is backed by real-world data in the form of shareable employability intelligence reports.

The components described in the block diagram of the decentralized market-based labor platform 106 may be further broken down into more than one component and/or combined in any suitable arrangement. Further, it is possible that one or more components may be rearranged, changed, added, and/or removed without deviating from the scope of the present disclosure.

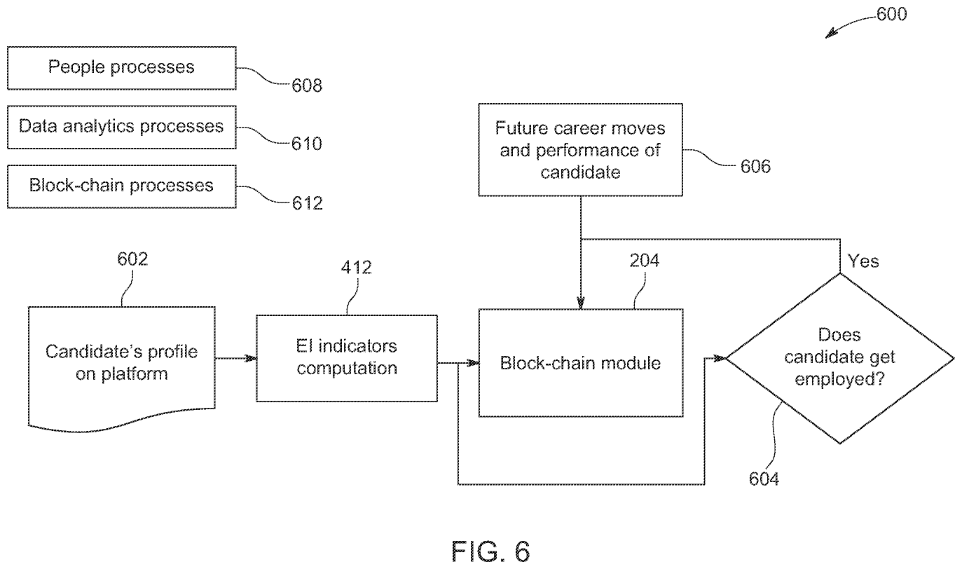

In an example embodiment, the decentralized market-based labor platform 106 may be embodied in one or more of several ways as per the required implementation. For example, the decentralized market-based labor platform 106 may be embodied as a cloud-based service, a cloud-based application, a cloud-based platform, a remote server-based service, a remote server-based application, a remote server-based platform, or a virtual computing system. As such, the digital employability assets on the decentralized market-based labor platform 106 may be configured to operate inside the user equipment 102. In some example embodiments, the user equipment 102 may be any user accessible device such as a mobile phone, a smartphone, a portable computer, a personal computer, a laptop, a tablet, a phablet, a personal digital assistant (PDA), and the like. The user equipment 102 may comprise a processor, a memory, and a communication interface. The processor, the memory, and the communication interface may be communicatively coupled to each other. The general architecture of the user equipment 102 will be described in detail in FIG. 6.

FIG. 1C illustrates a high-level system diagram 100c of the computing system 106, according to one or more example embodiments. FIG. 1C provides an overview of the computing system 106. FIG. 1C is described below in conjunction with FIG. 1B. The computing system 106 is configured to obtain from the user equipment 102 user data associated with users registered with the decentralized market-based labor platform. The user data is used to generate a digital user profile for each of the registered users. The computing system 106 is further configured to use data models and algorithm 118 to perform data analytics on the user data to generate digital employability assets for the user to exchange in block chain-enabled digital labor marketplace 116 to obtain employability.

The computing system 106 is further configured to generate real-time labor market data and industry analytics 120 for a specific user based on personal data and relevant records 122 of the specific user by using the data models and algorithms 118. The data models and algorithms may be implemented by the ML module 112.

The system 100a is further configured to generate personalized graphic user interfaces or dashboards 124 for each of the registered users based on the digital user profiles and location specific socio-economic data as well as specific academic and industry data associated with each user. The dashboards 124 are configured to represent, but not limited to, employment-related smart contracts, employability assets, employability intelligence scores corresponding to various skills of the jobseeker, and the like.

Further, the computing system 106 is configured to use blockchain recording for verification, tracking and aggregation of the digital employability assets. To that end, the digital user profiles of the users are minted 128 into the virtual tokens (NFT) for smart contacting. The smart contracting allows the user to trade 130 the NFT, indicative of a verified digital user profile, in the digital labor marketplace 116 using the data models and algorithms 118.

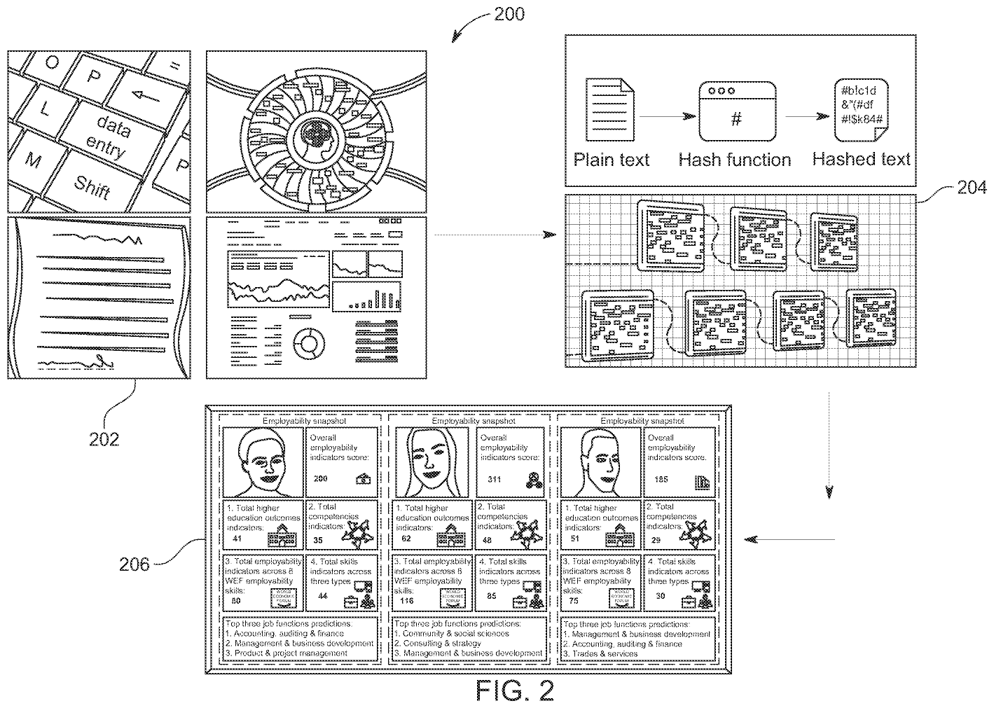

FIG. 2 illustrates a high-level flow diagram 200 of the computing system 106, in accordance with one or more example embodiments. The computing system 106 is configured to enable the participant to exchange NFT 114 indicative of digital employability assets of the jobseeker in a block chain based digital labor marketplace 116.

To that end, the computing system 106 is initially configured to assist the jobseekers to develop digital employability assets by combining educational knowledge of the jobseekers with their technical and soft skills.

To that end, the computing system 106 is configured to obtain data 202 associated with a jobseeker, where the data 202 comprises educational knowledge, skills, and competencies of the jobseeker. The data 202 (also referred to as “user dataset”) may be derived from a multi-source intelligence approach that fuses and analyses multiple user datasets of the jobseeker to produce a quantifiable employability estimate.

Further, the computing system 106 is configured to use advanced analytics using a blockchain module 204 to generate a user-centric employability intelligence record and provide a decentralized labor marketplace for job consideration. The blockchain module 204 is configured to implement blockchain technology based digital labor marketplace 116. A blockchain comprises a distributed electronic ledger that records transactions between source identifier(s) and destination identifier(s). The blockchain uses a data structure that holds a list of transactions (s). The transactions are organized into blocks, and each block (save the first) refers to or is connected to a previous block in the chain. The blockchain is maintained by computer nodes, which cryptographically validates each new block and hence the transactions contained inside it. Importantly, the validation process offers a method for agreement, allowing for the trustworthy exchange of value through communication networks such as the Internet.

The computing system 106 is further configured to generate a dashboard 206 providing real-time labor market data and industry relevant case studies in the analytics platform to facilitate self-organized user work-study groups. The dashboard 206 is further configured to provide personalized graphic user interfaces comprising digital employability assets and entitlements, from the digital user profiles and location specific socio-economic data as well as specific academic and industry data. The dashboard 206 may further indicate one or more employability indicators associated with one or more different employability assets.

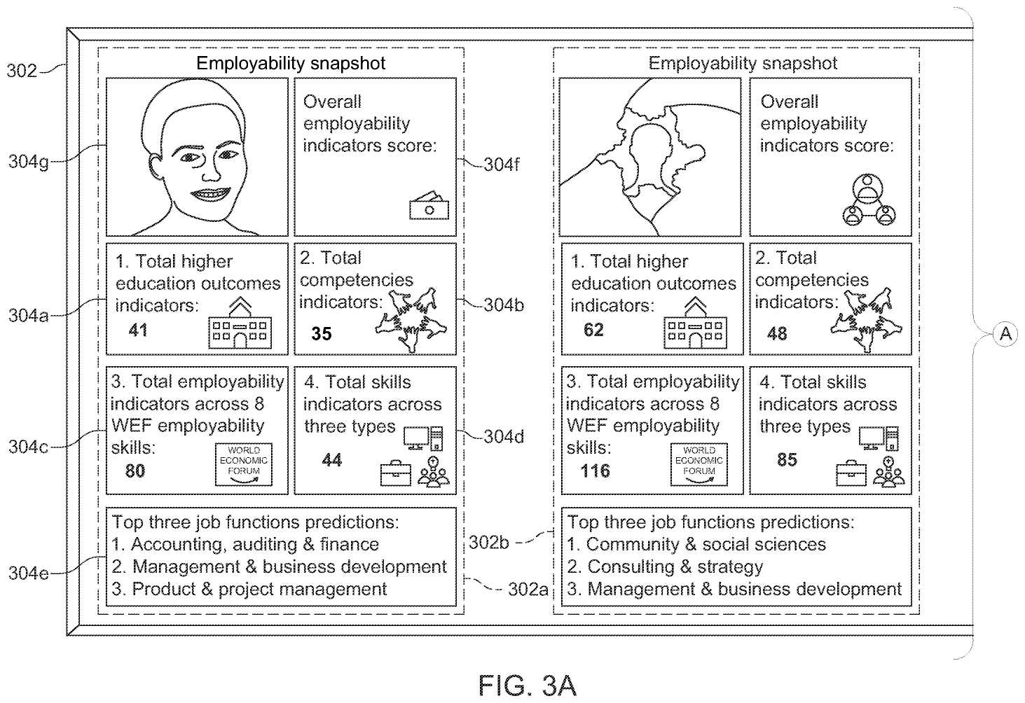

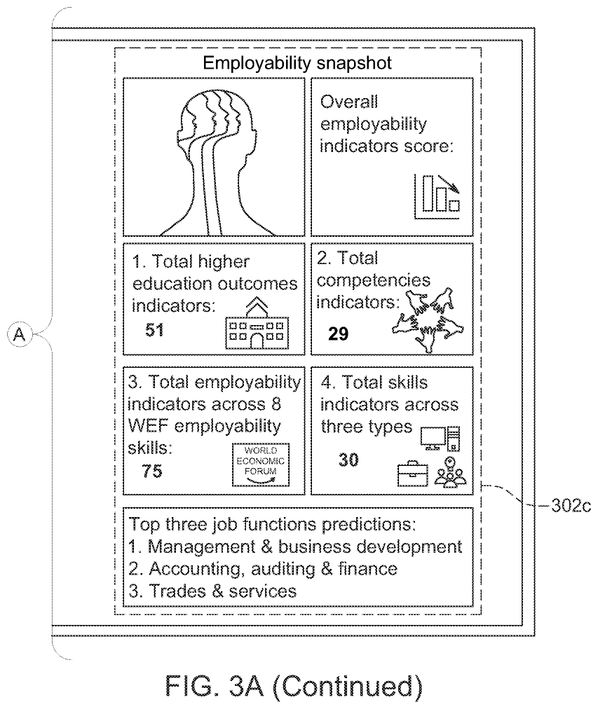

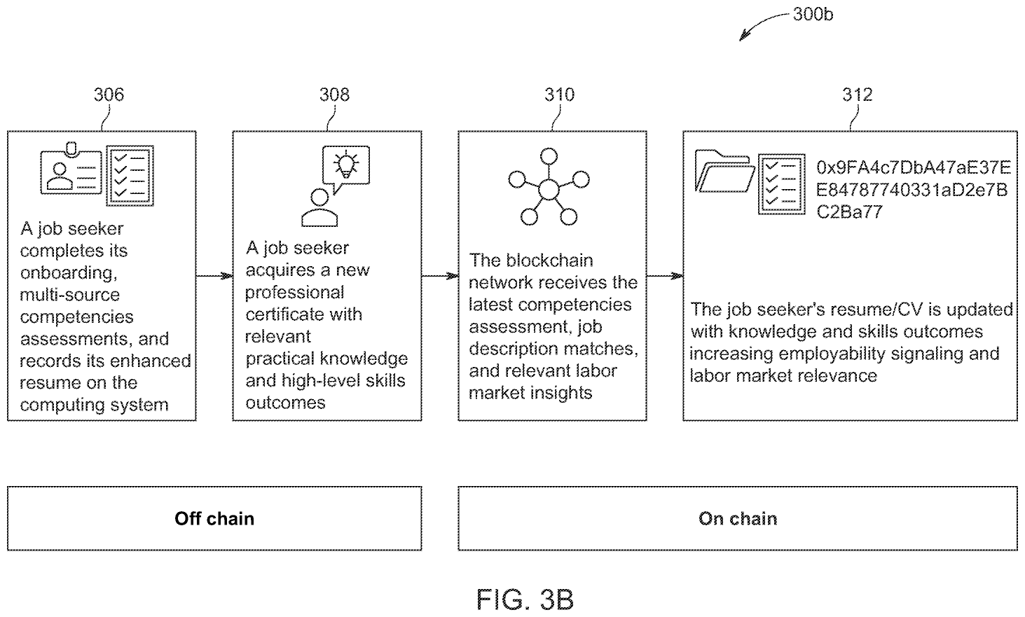

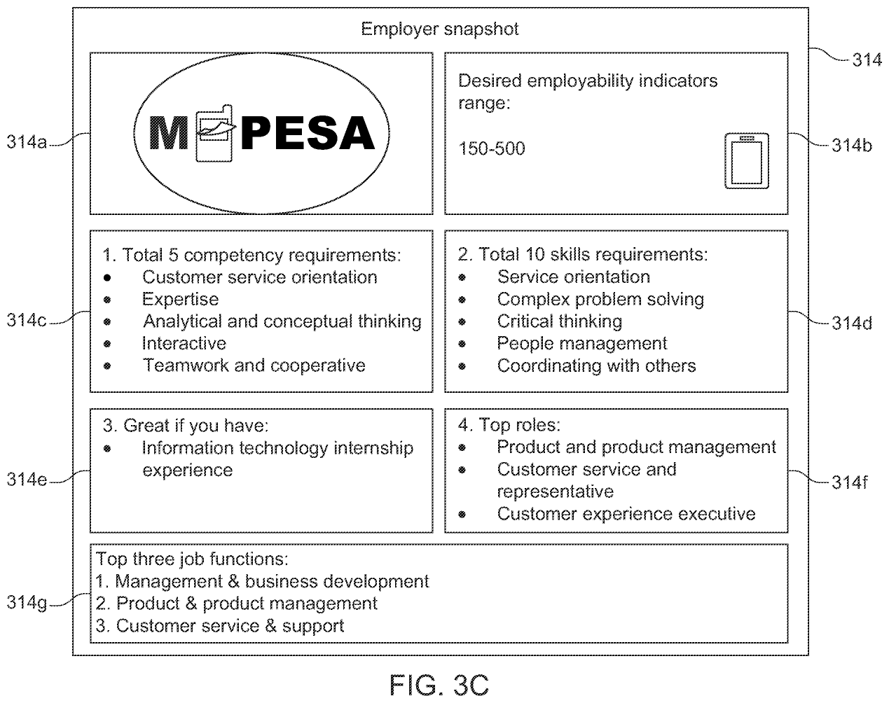

In some embodiments, computing system 106 is configured to generate the dashboard 206 comprising distinct types of information based on a type of the user such as job seeker and employer. Thus, based on the type of the user, different types of dashboards are generated. For example, a dashboard corresponding to the jobseeker may comprise information associated with employability of the jobseeker such as shown in FIG. 3A below. Alternatively, a dashboard corresponding to the employer may comprise information associated with the employer that requires specific types of skill for specific types of jobs as shown in FIG. 3C.

FIG. 3A illustrates an employability dashboard 302 comprising a plurality of employability snapshots 302a, 302b, and 302c of a plurality of users, in accordance with one or more example embodiments. Each employability snapshot (for example, 302a) of the plurality of employability snapshots 302a-302c is generated based on the digital user profile of the corresponding user. Further, each employability snapshot (for example, 302a) comprises a snapshot of the assessment and summary data, with the assessment and summary data presented on one or more dashboards. The employability snapshot further comprises a visual interface that displays one or more of the following: higher education outcomes indicators 304a generated based on educational background (or academic qualification data) of the user (in this case a jobseeker), competencies indicators 304b, where the competencies indicator 304b may be generated based on work exposure data, professional maturity references data, psychometric test results data and the like associated with the user. The visual interface of the employability snapshot further displays employability indicators across various (at least eight) world economic forum (WEF) employability skills 304c, skills indicators of several types (at least three such as communication skills, technical skills, emotional intelligence, and the like) 304d, and overall employability indicators score 304f generated based on scores 304a-304d. The overall employability indicators score 304f allows the employers for a streamlined and focused “filter-in” sourcing and recruiting, cross-leveling of graduates in the digital labor marketplace 116 to more professional fields, and competencies categorization and quantification of the jobseekers.

In some embodiments, each of the employability snapshot comprises a filed 304g, where the user may upload its photo. In case, the user does not upload its photo, the employability dashboard 302 is configured to automatically select a photo for the user.

Further, each score of the plurality of scores 304a-304d is an employability indicator score for distinct categories. The employability indicators score is used to predict the likelihood that a jobseeker has the applicable knowledge as well as cross-cutting skills indicator and abilities indicator to fulfill entry-level job requirements and responsibilities. The higher the employability indicators score, the more likely the jobseeker will be a long-term fit for roles requiring relevant academic knowledge and transferable skills as well as professionally oriented abilities and attitudes.

Further, the visual interface of the employability snapshot displays job function predictions 304e. For example, the job function predictions 304e may be generated based on the scores 304a-304d of a specific user may comprise information such as the specific user is suitable for jobs involving functionalities such as: 1. accounting, auditing, and finance, 2. management and business development, 3. product and project management, and the like.

In an embodiment, a proof of concept (POC) and a minimum viable product (MVP) may be developed with features such as user data set collection, information fusion, analysis, visualization, and assessment and intelligence dossier creation, product sharing, and peer-to-peer networking. Requirements for the users, such as the job seekers for development of the MVP may include automated account creation, automated identity and academic credentials verification, automated initial questionnaire and resume submission, personalized self-assessment creation, automated referee assessment request, verification, and submission, and automated self and referee assessment visualizations as well as analyst-driven assessments. The requirements may further include Automated third-party job role competencies assessments integration, automated third-party competencies visualizations and analyst-driven assessments, automated and job seeker-driven multi-source talent intelligence dashboard configuration and text summarization, job seeker-driven drag and drop resume and cover letter templates, and automated talent intelligence sharing and peer-to-peer communication.

Some embodiments are based on the realization that employers frequently face a problem of verifying information, associated with the jobseeker, mentioned in the jobseeker's profile or a CV. For example, the jobseeker may have mentioned in its resume that the jobseeker had completed a degree at a particular university or worked for a particular company. However, the employers face the problem of verifying this information.

On the other hand, the jobseeker faces problems such as the jobseeker often lacks work history and practical experience that may be hidden in the extracurricular activities and professional interests of the jobseeker. The jobseeker also faces skills mismatches, automated applicant tracking system gatekeepers, and requirements to constantly update resume/CV data on multiple applicant platforms. In many cases, these platforms limit work opportunities to a few in-demand fields that may not align with the jobseeker's interests and purposes.

Some embodiments are based on the realization that a blockchain identity solution could automatically verify the jobseeker's credentials and information for relevant third parties and/or employers. Accordingly, the present disclosure uses the computing system 106 configured to use a permissioned blockchain and personalized data analytics that enables the jobseeker to create and market jobseeker-owned virtual (also referred to as “dynamic”) resumes/CVs as well as other employability assets employers find attractive. The employers from diverse professional fields can quickly source, verify, and filter the jobseeker's employability potential on the decentralized market-based labor platform 106 with a link or by requesting the jobseeker's record during the initial hiring process. In addition to verifying the jobseeker's identity and credentials, the decentralized market-based labor platform 106 may provide insights designed to help employers assess jobseeker's employability potential and immediate organizational value. This type of verification derives from dynamic and multi-source resumes/CVs that can be used throughout the entire sourcing and recruitment process because the dynamic resumes/CVs can be updated automatically in real-time.

FIG. 3B illustrates steps of a method 300b for generating a dynamic resume for a jobseeker, in accordance with one or more example embodiments. At step 306, the jobseeker may complete their onboarding on the decentralized market-based labor platform 106, multi-source competencies assessments, and record their enhanced resume on the computing system 106. The enhanced resume may comprise employability intelligence scores corresponding to different skills of the jobseeker.

At step 308, the jobseeker may acquire a new professional certificate with relevant practical knowledge and high-level skills outcomes. For example, the jobseeker may complete an online certification course that may provide the jobseeker with the high-level skills required for a specific job profile. The jobseeker may upload the new professional certificate to the computing system 102. The steps 306 and 308 are performed off chain i.e., without using block chain technology. Further, to verify new information provided by the jobseeker, for example a new professional certificate the following steps 310 and 312 are performed on the chain i.e., using the blockchain technology.

At step 310, the computing system 102 may provide the professional certificate to the blockchain network along with the latest competencies assessment of the jobseeker, job description matches, and relevant labor market insights.

At step 312, the blockchain network is used to verify the provided information associated with the jobseeker and generate a dynamic resume/CV of the jobseeker comprising updated knowledge and skills outcomes that increases employability signaling and labor market relevance of the jobseeker. The blockchain network records employability assets like the jobseeker's resume/CV to generate the dynamic resume, where the dynamic resume is portable, cryptographically secure, decentralized, fraud-resistant, and can be updated in real-time. For example, suppose that the jobseeker obtains a new skillset or a new job role, in that case, the dynamic resume is automatically updated from a new dataset comprising new skillsets or new job role, and the like.

FIG. 3C illustrates an employer dashboard comprising an employer snapshot 314, in accordance with one or more example embodiments. The employer snapshot 314 comprises a field 314a comprising a logo of the employer and a field 314b indicating a range of desired employability indicators, for example, between 150-500. The employer snapshot 314 is further configured to display a competency requirement field 314c, where the employer describes top 5 competency requirements. For example, in FIG. 3B, an employer named MPESA requires its employee to possess competencies 314c such as 1. customer service orientation expertise, 2. analytical and conceptual thinking, 3. Initiative (leadership skills), 4. teamwork and cooperation. The employer snapshot 314 further displays required skills in sills requirements filed 314d. For example, the skills required by the employer MPESA are: 1. service orientation, 2. complex problem-solving, 3. critical thinking, and 4. coordinating with others.

The employer snapshot 314 further comprises a preferred qualification field 314e that indicates preferred qualifications/experiences (for example, information technology internship experience) of the candidate jobseeker for the specific role. The employer snapshot 306 further comprises job roles field 314f that lists job roles required by the employer. For example, the employer MPESA requires candidates for job roles such as product and product-management roles, customer service representative, and customer experience executive. Finally, the employer snapshot 314 comprises a field 314g to indicate job functions. For example, MPESA requires job functions such as 1. Management and business development, 2. product and project management, 3. customer service and support.

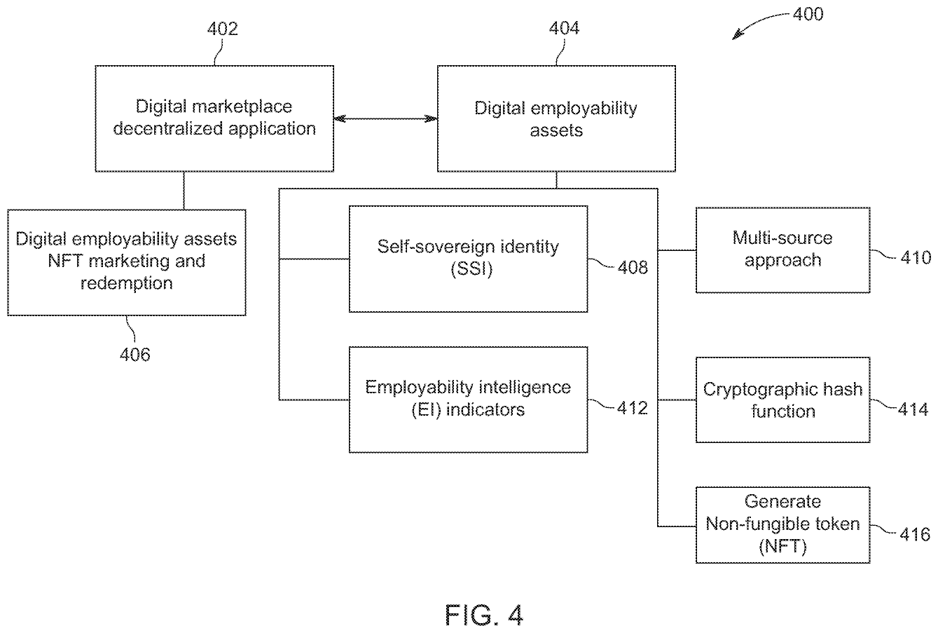

FIG. 4 illustrates a block diagram of a blockchain platform 400 that is executed in the computing system 106 of FIG. 1, in accordance with one or more example embodiments. FIG. 4 illustrates an architecture of the computing system 106 that enables trading of the digital employability assets and entitlements using data analytics and cryptographic evidence rather than human uncertainty and prejudice. The blockchain platform 400 ensures that both parties (jobseekers and employers) are assured about verified skill levels and labor market relevance of the jobseekers, by using a fusion of advanced data analytics and block chain technology. The blockchain platform 400 further ensures that the jobseekers and the employers are mutually able to qualify and quantify employability as well as labor market attractiveness.

To that end, the blockchain platform 400 is configured to generate digital employability assets 404 for each user, where the digital employability assets 404 is indicative of skills, qualification, experience, and competencies of the user. The digital employability assets 404 are used for trading in a digital labor marketplace, where the digital labor marketplace is based on decentralized application 402 such as blockchain network. To trade the digital employability assets 404 in the digital labor marketplace, a non-fungible token (NFT) 406 (also referred to as “digital employability token”) is generated based on the digital employability asset, where a candidate jobseeker, may use the NFT for marketing 406 in the digital labor marketplace and an employer may use the NFT 406 associated with the jobseeker for redemption 406. When the employer redeems digital employability token, the employer becomes a “token holder,” and the employer is granted specific rights. The specific rights may entitle the employer to request the candidate jobseeker employability assessments as well as conduct initial interviews, tests, or tryout assuming that the candidate jobseeker is competitive and can add immediate value to the organization. Thus, the redemption of the digital employability token provides specific rights to the token holder which makes the digital employability token valuable or useful from a hiring perspective.

Further, to generate the digital employability assets 404, initially user data is obtained via multi-source approach 410, where the multi-source approach 410 comprises obtaining the user data from various sources, such as social media, resumes, and the like, associated with the user. The multi-source approach 410 further comprises receiving questionnaires required to be filled by the job seekers, assessments to be completed by the job seekers along with other data and information sources. The talent intelligence staff determines the relevance and reliability of the received information, integrates the received information with current talent intelligence holdings, and through analysis and evaluation, determines changes in job seeker competencies, opportunities to make an impact and organizational behaviors based on the Rewarding to deal with, Able to do the job, and Willing to work hard (RAW) model. Thus, well-being of the job seekers as well as inclusive and cost-effective talent management is obtained. The talent intelligence is used to develop the intelligence products necessary to evaluate talent determinants as well as support job seeker and employer talent management decisions. Furthermore, the talent intelligence production is continuous and occurs throughout the talent management cycle. In an embodiment, the talent intelligence products are initially developed during the user onboarding phase and updated as needed throughout the personalized process based on information gained from continuous and the multi-source assessment.

The RAW model may output rewarding indicators based on organizational citizenship, able indicators based on dependent and independent knowledge (also called practical and procedural as well as theoretical knowledge), experience and skills, and cognitive abilities and optional IQ test, and willing indicators based on attitudes, personality, and emotional intelligence of the job seeker. The RAW model may require inputs such as structured interviews, assessment modules and boot camps, IQ tests, personality assessments, biodata, resume, 360-degree or multi-rater feedback survey, situational judgment tests (SJTs), industry assessments and social media information.

The user data obtained is used to generate digital user profiles comprising one or more employability intelligence (EI) indicators 412, where each EI indicator 412 is an estimate of graduate employability potential and professional maturity. Further, the blockchain platform 400 is configured to generate a digital user profile comprising a user specific dashboard to display EI indicators 412 along with other information and reports as described in FIG. 3A and FIG. 3C above.

Finally, a cryptographic hash function 414 is used for minting the digital user profile, where minting generates NFT 416. The NFT 416 provides a self-sovereign identity (SSI) 408 to each user. The SSI 408 is a digital identity of the user. Thus, the computing system 106 is self-sovereign that allows its users to control their verifiable credentials (such as EI indicators 412) that they hold, and their consent is required to use those credentials. This reduces the unintended sharing of user's personal data. Further, in the blockchain platform 400 users generate and control unique identifiers called decentralized identifiers (DID). The DIDs are a new type of identifier that enables verifiable, decentralized digital identity. A DID refers to any subject (for example, a jobseeker, an employer such as organizations) as determined by the controller (i.e., either the jobseeker or the employer) of the DID. Thus, the blockchain platform 400 enables automatic verification of the users and further, enables the user to use their NFTs, in the block chain based digital labor marketplace, for marketing and redemption.

In some embodiments, the DIDs and verifiable credentials (VCs) are used to track digital employability assets of the jobseeker. In some embodiments, the VC may be issued to the jobseeker by an organization when the jobseeker completes an employability intelligence evaluation of the organization. Every jobseeker has a DID registered with a firm in which the jobseeker wishes to seek job opportunities. The firm may access the DID of the job seeker through the corporate registry. Furthermore, the jobseekers may keep track of their professional maturation and employability by maintaining an employability intelligence portfolio on their own server. Following that, the jobseekers can mint their most recent EI indicators 412 portfolio as NFT 416. The jobseekers may also use the NFT 416 to trade specific digital employability assets with one or more employers that require candidates with the specific digital employability assets on the digital labor marketplace 116. The NFT 416 serves as a proof material connected with the DID to demonstrate the legitimacy of the credentials of the jobseeker, allowing the jobseeker to be evaluated for a position at an organization of the employer. The jobseekers must update their cryptographic material for their digital employability assets as needed. Following these revisions, all credentials may still be confirmed as granted and re-marketed in the digital labor market if necessary.

In some embodiments, the DID associated with the jobseeker, the VC of the job seeker, and digital employability assets of the jobseeker are used together to generate the digital employability token. In this way, the proposed digital employability token is backed by cryptographically verified personal attributes and multi-source employability assessments.

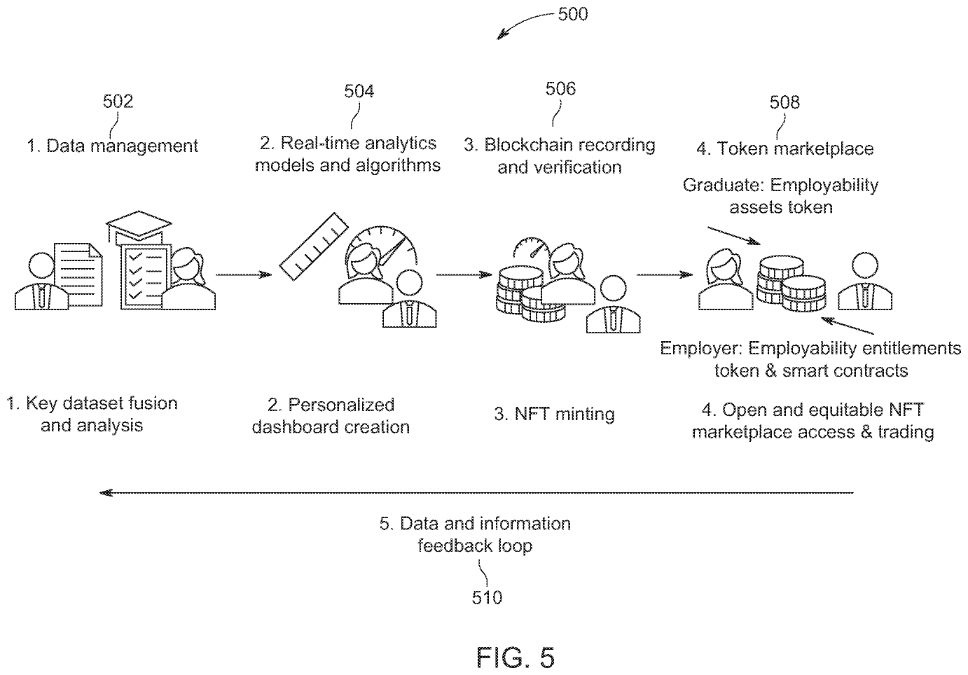

FIG. 5 illustrates a detailed flow diagram 500 of a method executed by the computing system 106 for generating a digital employability token, according to one or more example embodiments. FIG. 5 shows an example of creation and management of the digital employability asset, labor market stakeholder interactions, and digital employability asset exchange, between parties for employability entitlements and smart contracts system.

At step 502, the computing system 106 performs data management. To that end, a user data set (also referred to as a “key dataset”) associated with one or more EI indicators of the user is obtained for fusion and analysis using one or more machine learning algorithms and data analytics. The user data set is analyzed using the advanced machine learning algorithms to create, at step 504, a digital user profile record. The jobseekers begin the EI production process by performing primary source verification (PSV), which is followed by the fusion and analysis of multi-source EI indicators to generate a customized digital EI dossier. After completing the EI dossier, the jobseekers may customize their visual EI dashboard and estimations to provide their most complete image to employers.

At step 506, the digital user profile record of the user is stored on the blockchain as a secure and immutable digital employability asset. The digital employability asset and the underlying EI indicators data can be shared with potential employers as part of the usual job search process or “minted” as an NFT. The NFT is used to produce digital authenticity of the certificates of the jobseeker for employment intelligence dossiers. Tokenization using the NFT entails putting the digital employability assets from outside the blockchain's employability intelligence dossier on the blockchain based network (i.e., the digital labor marketplace). Each NFT is accompanied by a digital user profile record. On the block chain, the NFT includes all information and history of employment intelligence dossiers.

According to some embodiments, integration of the digital user profile record with their NFT counterparts using digital ID technology. Tokenization and the formation of NFTs take place prior to job seekers entering the digital labor marketplace. Finally, aesthetically appealing digital NFTs provide a glimpse of the graduate's EI dossier asset.

At step 508, the jobseekers advertise their NFTs in the digital labor marketplace 116 for employer's job role consideration. Thus, the system 100a provides the circumstances for real-world interviews and job role tryouts that are facilitated by trust and more symmetrical employability information. The digital labor marketplace 116 enables participants to sell, redeem, and invest in employability assets that are validated by employability intelligence and cryptographic procedures on a peer-to-peer basis. Finally, at step 510, the data and information associated with the digital user profile record is provided as feedback for data management.

FIG. 6 illustrates a high-level block diagram of processes utilized for generating a digital employability token, in accordance with one or more example embodiments. FIG. 6 is described below in conjunction with FIG. 1A. The high-level block diagram 600 illustrates utilization of data associated with the user (such as a candidate) to generate the digital employability token and storage of the digital employability token in the blockchain module 204.

A candidate profile 602 (such as the digital user profile) may be generated for each user. The candidate profile 602 may be utilized to compute the EI indicators 412. The computed EI indicators 412 may be stored in the blockchain module 204. Further, if the candidate gets employed, information related to the employment of the candidate 604 may be stored in the blockchain module 204. Furthermore, future career moves and performance of the candidate 606 may be stored in the blockchain module 204. For example, the computed EI indicators 412, the information related to the employment of the candidate 604 and the future career moves and performance of the candidate 606 may be stored as the digital employability token in the blockchain module 204.

The digital employability token may be generated based on one or more processes, such as people processes 608, data analytics processes 610 and blockchain processes 612. The people processes 608 may require a significant amount of human involvement alongside technology. For example, the onboarding process of the candidate may reduce employability information asymmetry between job seekers, such as the candidates and employers. Such reduction may enable job seeker competencies awareness, job role matching, and employer decision-making through stronger candidate employability signaling. The onboarding process may be a foundation for analyst, candidate, and employer sourcing and recruitment workflows. The onboarding objective is for the candidates and the employers and users such as, employability intelligence analysts to leverage a standard set of entities and associations to develop custom workflows. In other words, the onboarding process may be utilized to forge relationships with customers, such as the employers and the university graduates market segment. Furthermore, the data collected during the onboarding process may become the foundation for information processing and verification as well as employability intelligence production. Moreover, initially hired users for the people processes 608 may likely be on-boarding agents and/or employability intelligence analysts enabling job creation and professional development.

Typically, the onboarding processes may be associated with job seekers or the graduate and the employer. For the job seekers onboarding process, an introductory and educational module may be created, standardized and multi-dimensional/source competencies assessments may be created, a template-based resume and cover sheet may be developed and additional resources e.g., interview training, industry case studies library, and competencies-based applying may be determined.

For the employer onboarding process, the introductory and educational module may be created, the standardized and multi-dimensional/source competencies assessments may be created, a template-based job description and application form may be developed and additional resources e.g., employability intelligence reports and competencies-based hiring training may be determined.

The data analytics processes 610 are utilized for example, for computation of the EI indicators 412. The computing system 106 may utilize a use case of data in recruitment from a level below i.e., from data analysis before moving into the sophistication of an artificial intelligence (AI) or the ML model. The EI indicators 412 may be utilized to essentially answer a question, “What can this candidate bring to the table?”. Such a question may answer the employability potential of the candidate as well as immediate organizational impact and long-term value. Thus, the computing system 106 utilize a multi-source approach to the employability potential of the candidate holistically. Once EI indicators 412 may be computed, the EI indicators 412 may be used as the basis for which the data may be recorded and tracked on the blockchain module 204.

The EI indicators 412 may further lead to the creation of the employability dashboards for each graduate that may provide the employer an immediate oversight on the capability of the candidate, along with scores such as “Graduate Employer Compatibility” that may compute a score that may be descriptive of a compatibility of the candidate for the given job description. Such metrics may be visualized as the one or more dashboards and may be viewed by one or more in-house team of analysts who may help identify suitable candidates for certain job roles and expedite the discovery process for employers.

The blockchain processes 612 may be utilized to store and transmit the digital employability token associated with the candidate. The blockchain module 204 may include a growing list of candidate records or blocks, each storing a data unit, such as employability asset portfolio as the NFT 416. The blocks may be connected to each other using cryptography to ensure secure data transmission. The blockchain platform may leverage block-chain governance, security of verification network and efficiency along with a user-centric decentralized digital labor marketplace application. The block-chain may enable decentralized candidate information verification as well as intelligence analysis and production. The decentralized verifier or validator network may be critical to the multi-source employability intelligence approach. The computing system 106 may leverage the block-chain technology to create a peer-to-peer (P2P) environment that may transform opaque competencies of the candidate into the competitive digital employability asset portfolio and connect them with available decent work opportunities.

The blockchain processes 612 workflow my include candidate data collection and processing, candidate information verification, candidate EI indicators production and employability intelligence-driven decision-making that may include candidate filtering, comparison and selection.

Thus, the main technologies that may be utilized for the market-based labor platform 106 may be the blockchain technology and the analytics employability intelligence technology. The blockchain technology may be utilized to record and track candidate employability asset portfolios, and to record the latest updates of careers of the users dynamically. Such blockchain technology may provide tamper-proof data at lower cost of verification. The analytics employability intelligence technology may be utilized to help the employers identify the best candidates for open roles and help better drive company processes. Such analytics employability intelligence technology may be used in data-driven companies and promote data-driven practices in the recruitment process.

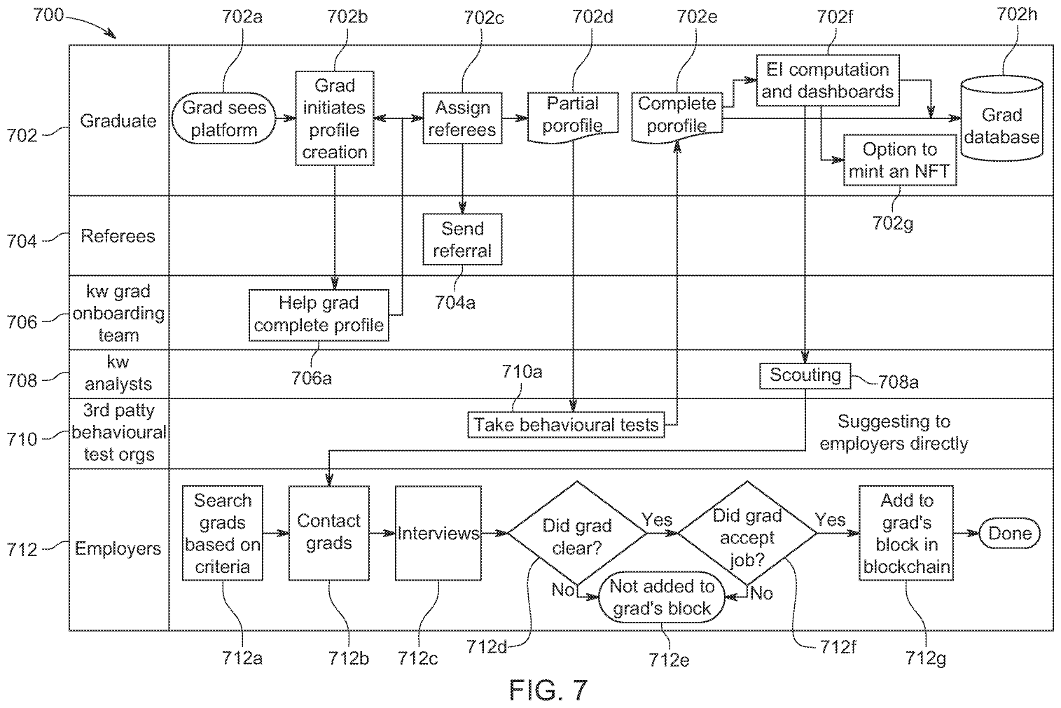

FIG. 7 illustrates a high-level business process diagram 700 associated with a blockchain platform that is executed in the computing system of FIG. 1, in accordance with one or more example embodiments. FIG. 7 is described below in conjunction with FIG. 1A. FIG. 7 may describe processes involved for each participant. The different participants of the market-based labor platform 106 may be graduates 702, referees 704, on-boarding team 706, analysts 708, third-party behavioral test organizers 710 and employers 712.

The graduates 702 may refer to the university graduates or the job seekers. The referees 704 may refer to users who may provide references for the graduates 702. The referees 704 may be nominated by the graduates 702. The on-boarding team 706 may refer to a support team deployed to send emails and get on calls with the graduates 702 to help the graduates 702 with completing the candidate profile on the platform 602. The analysts 708 may refer to a core team that may perform analysis on the different candidate profiles as well as the employer profiles in order to understand about the graduates and the competencies, thus the graduates 702 to be identified by employers 712. The third-party behavioral test organizers 710 may refer to external platforms where the graduates 702 may appear for online behavioral and psychometric tests. The third-party behavioral test organizers 710 or multi-source platforms provides multiple personalized assessments that may analyze indicators or conditions that signal diverse job role competencies, adaptability, and organizational or culture fit. The employers 712 may refer to the companies looking for the graduates 702.

At 702a, the graduate identifies the market-based labor platform 106. At 702b, the graduate initiates the creation of the portfolio. At 706a, the on-boarding team 706 may receive the request to help the candidate in creation of the portfolio. At 702c, the graduate assigns referees (such as one or more referees of the referees 704). At 704a, the referees may send referrals for the candidate. At 702d, a partial profile of the candidate may be created. At 710a, the third-party behavioral test organizers 710 may provide behavioral assessment tests for the candidate and the candidate may appear for them. At 702e, the candidate profile may be completed based on the results of the behavioral assessment tests received from the third-party behavioral test organizers 710. At 702f, the EI indicators may be computed, and the candidate dashboard may be created. At 702g, an option to mint the NFT may be given. At 702h, the candidate data may be stored in the database, such as the blockchain module 204. At 708a, the analysts 708 may scout the graduates to employers based on the EI indicators. At 712a, the employers 712 may search the graduates based on the criteria. At 712b, the employers 712 may contact the graduates scouted by the analysts 708. At 712c, interviews may be conducted. At 712d, it is checked if the graduate has cleared the interview. At 712e, the block of the graduate may not be updated if the graduate has not cleared the interview. At 712f, it is checked if the graduate has accepted the job after clearing the interview. At 712g, the block of the graduate may be updated in the blockchain module 204 if the graduate has accepted the job.

In an exemplary scenario, the user dashboard may include initial assessment, self-assessment, external assessment such as references and third-party assessments, job market and industries assessment. At stage 1, the user may require filling up the questionnaire form that may include personal and professional information, web URL to resume, web URL to other employment-based applications and web URL to relevant work samples. At a stage 2, the user may require filling up the personalized user self-assessment, form that may include talent analyst-created based on job role competencies framework and initial questionnaire analysis. At a step 3, the self-assessment may be called or reported. For example, the talent analyst-driven self-assessment may be reviewed, and personalized external assessment may be discussed. At a step 4, the user references may be requested, and personalized third-party assessments may be performed. For example, the third-party assessments reference testimonials may be populated. At a step 5, external assessment call or report & all-source dashboard may be reviewed. For example, the talent analyst-driven external assessment may be reviewed, and job role competencies dashboard may be reviewed. The user's job role competencies dashboard may be the fusion, analysis, and visualization of the steps 1 to 5 or their self and external assessments as well as relevant industry and job market data collected by analysts. Moreover, a dynamic dashboard may be created in the step 1, so it builds as new intelligence, for example, possible gamification features e.g., levels or skins may be generated.

The job seekers may complete the personalized job role competencies, organizational fit and professional lifestyle assessments from customized and credible sources. The assessments may be synthesized from the talent analysts and dashboard may be created. The seekers may share the encrypted information to the employers for a mutual decision.

Advantageously, the job seekers and employers may utilize the sourcing and recruitment benefits of the blockchain through cost reduction and process involvement aligned with job creation initiatives. Further, post on-boarding and creation of the employability assets portfolio has several advantages. For example, the candidates may be discovered, compared and selected through the permissioned or consortium blockchain network. The time waiting for information may be reduced as applicants provide data (employability intelligence assessments) in real-time which drives insights and trust. The on-boarding and creation of the employability assets portfolio follows a global taxonomy and industry standards, such as standardized business objects and entities ontology, standardized resume, cover letter, job description, and application form workflows and standardized psychometric tests and assessments. The computing system 106 may further allow compliance and risk validation, such as avoidance of unethical or nepotistic hiring practices, avoidance of identity or credential fraud, allowing diversity, equity and inclusion, and national and regional youth employment incentivization. The computing system 106 may further provide real-time responses to job seekers and employer requirements. The computing system 106 may further enable creation of the personalized dashboards.

The computing system 106 thus enables the job seekers and employers to synchronize diverse talents, opportunities to make an impact, and organizational behaviors that foster well-being as well as enable inclusive and cost-effective talent management. The conventional talent management systems are typically cost-ineffective or incompatible with the future of work because they focus on inaccurate information exchange, negative screening filters, and short-term metrics such as resume keyword matching and time to hire. Additionally, entrenched applicant screening practices penalize workers of color disproportionately and go against organizational Diversity, equity, and inclusion (DEI) initiatives. On the other hand, the computing system 106 of the present disclosure provides multi-source talent intelligence production and sharing during the initial hiring phases such that employers may make intelligence-based decisions about the applicant's job role competencies, organizational fit, and professional lifestyle indicators and endorsements.

The conventional systems rely upon resume and cover letters that may only include static, single-source, and unverified machine-readable information such as education, certificates, key skills, work experience, volunteering information and references. The conventional systems may further use information such as about section of the job seeker, activity, interests, publications, languages and organization information. However, the computing system 106 utilizes dynamic, multi-source, and verified machine readable information in the job role competencies-based framework, such as multi-source personality profiling, purpose statement, professional interests and references/links, work integrated learning and experience, education (such as courses, learning outcomes and knowledge types), licenses and certifications (such as courses, modules and associated learning outcomes), practical and theoretical knowledge, skills (mapped by descriptor and level), languages, emotional intelligence assessment, psychometrics test/assessment, mentor, supervisor, and peer competencies endorsements, publications, direct organizational affiliation, volunteering or causes supported directly, values, goals, objectives and social impact associated with the job seeker.

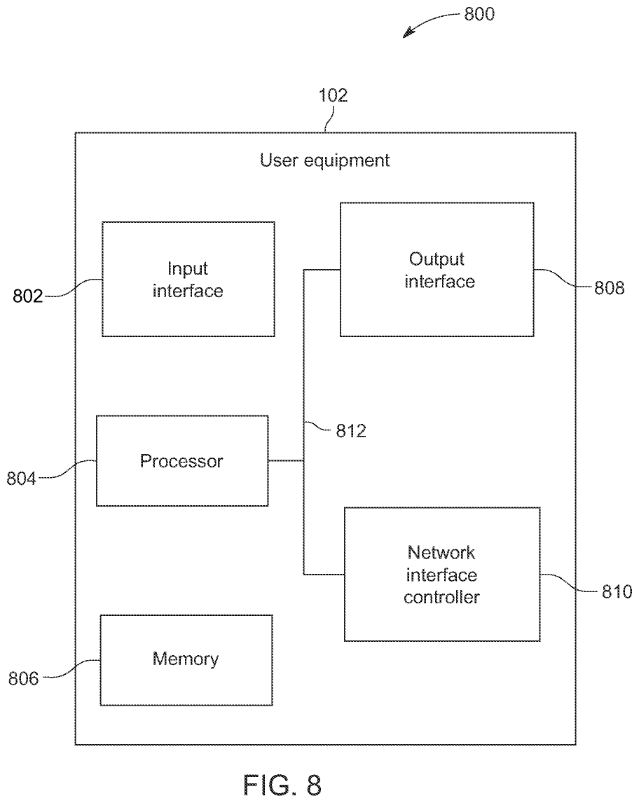

FIG. 8. illustrates a block diagram of the user equipment 102, in accordance with one or more example embodiments. FIG. 8 is described below in conjunction with FIG. 1A.

The user equipment 102 includes an input interface 802, at least one processor 804, a memory 806, an output interface 808, and a network interface controller (NIC) 810, all components being interconnected by a bus 812 for passing information.

The at least one processor 804 executes computer-executable instructions, such as for accessing the digital employability assets on the decentralized market-based labor platform 106 via one or more Application Programming Interface (API) calls, or via one or more network communication protocol messages. The at least one processor 804 may include a general-purpose processor, a special-purpose processor, and combinations thereof. For example, the at least one processor 804 may include a general-purpose central processing unit (CPU), a graphics processor, a processor in an application-specific integrated circuit (ASIC), a processor configured to operate using programmable logic (such as in a field-programmable gate array (FPGA)), and/or any other type of processor. In a multi-processing system, multiple processing units can be used to execute computer-executable instructions to increase processing power.

The memory 806 stores software implementing one or more innovations described herein, in the form of computer-executable instructions suitable for execution by the at least one processor 804. Specifically, the memory 806 can be used to store computer-executable instructions, data structures, input data, output data, and other information. The memory 806 can include volatile memory (e.g., registers, cache, random-access memory (RAM)), non-volatile memory (e.g., read-only memory (ROM), electrically erasable programmable ROM (EEPROM), and flash memory), and/or combinations thereof. The memory 806 can include operating system software (not illustrated). Operating system software can provide an operating environment for other software executing in the user equipment 102 and can coordinate activities of the components of the user equipment 102.

The user equipment 102 may additionally include storage (not shown separately) that can include electronic circuitry for reading and/or writing to removable or non-removable storage media using magnetic, optical, or other reading and writing system that is coupled to the at least one processor 604. The storage can include read-only storage media and/or readable and writeable storage media, such as magnetic disks, solid state drives, magnetic tapes or cassettes, CD-ROMs, CD-RWs, DVDs, or any other medium which can be used to store information and that can be accessed within the user equipment 102.

The user equipment 102 may include the network interface controller 810 for communicating with another computing entity using a communication medium (e.g., the network 104 shown in FIG. 1A).

The user equipment 102 may include the input interface 802 for interfacing with and receiving input signals from input device(s) from a physical environment. The input device(s) can include a tactile input device (e.g., a keyboard, a mouse, or a touchscreen), a microphone, a camera, a sensor, or another device that provides input to the user equipment 102.

The user equipment 102 may include the output interface 808 to provide an output interface to a user of the user equipment 102 and/or to generate an output observable in a physical environment using output device(s). The output device(s) can include a light-emitting diode, a display, a printer, a speaker, a CD-writer, or another device that provides output from the user equipment 102. In some examples, the input device(s) and the output device(s) may be used together to provide a user interface to a user of the user equipment 102.

The user equipment 102 is not intended to suggest limitations as to scope of use or functionality of the technology, as the technology can be implemented in diverse general-purpose and/or special-purpose computing environments. For example, the disclosed technology can be practiced in a local, distributed, and/or network-enabled computing environment. In distributed computing environments, tasks are performed by multiple processing devices. Accordingly, principles and advantages of distributed processing, such as redundancy, parallelization, and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, Packet Data Networks (PDNs), the Internet, intranets, and combinations thereof.

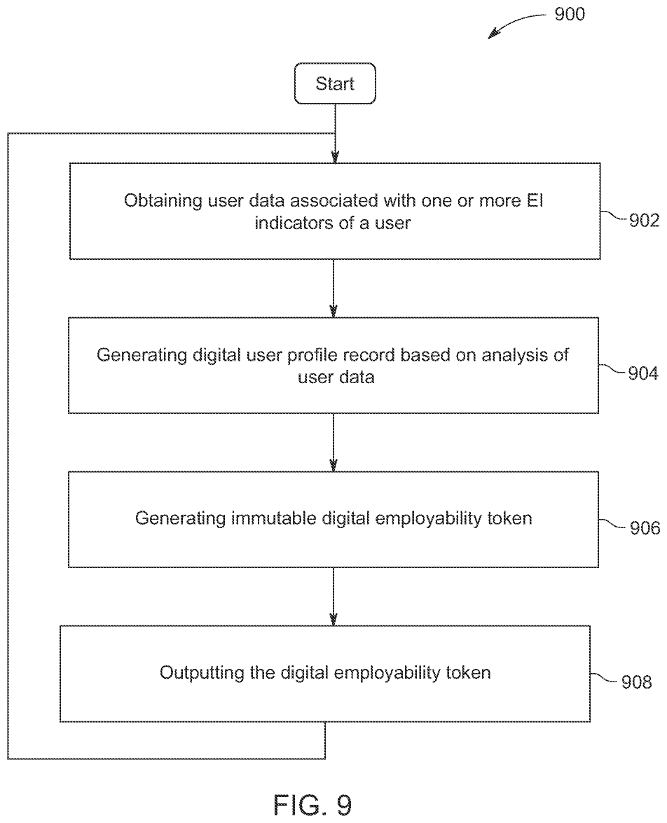

FIG. 9 illustrates steps of a method 900 for generating a digital employability token, in accordance with one or more example embodiments. The method 900 comprises obtaining user data associated with one or more EI indicators of a user. The user data may be obtained using multi-source approach, where the multi-source approach comprises obtaining the user data from the user, from a public forum, from a social networking portal, from a professional networking portal, from an email account, from direct submission by the user on the decentralized market-based labor platform 106, from a web crawler that crawls public profiles on the web, and the like.

At step 904, a digital user profile record is generated based on analysis of the user data by using a machine learning (ML) model. The machine learning model may be implemented using the ML module 112 (FIG. 1B). The digital user profile record comprises assessment data and summary data, where the assessment data and the summary data together being indicative of user employability potential. The digital user profile record further comprises EI indicators of the user generated using a multi-source intelligence technique that fuses and analyses a plurality of datasets associated with the user to provide a quantitative employability estimate.

At step 906, the digital user profiles are minted to generate an immutable digital employability token. The digital employability token is associated with a unique digital identity identifier. At step 908, the digital employability token is outputted for used by the user based on the minting process. The minting ensures that the digital user profiles are verified. Thus, the user, for example, the jobseeker may market its digital employability token in the digital labor marketplace for seeking job opportunities. On the other hand, the user, for example, the employer may redeem the digital employability token of a candidate jobseeker to request the candidate jobseeker employability assessments as well as conduct initial interviews, tests, or tryout assuming that the candidate jobseeker is competitive and can add immediate value to the organization.

Any of the disclosed methods can be implemented as computer-executable instructions stored on one or more computer-readable media and executed on a computer (e.g., any commercially available computer). Any of the computer-executable instructions for implementing the disclosed techniques as well as any data structures and data created and used during implementation of the disclosed embodiments can be stored on one or more computer-readable storage media. For example, the computer-executable instructions can be part of a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, or other such network) using one or more network-attached computers.

Accordingly, blocks of the methods shown by flow diagrams support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

I/We claim:

1. A computing system comprising:
at least one processor; and
a memory having stored thereon computer-executable instructions that are structured such that, when executed by the at least one processor, cause the computing system to:
obtain user data associated with one or more employability intelligence (EI) indicators associated with a user;
generate a digital user profile record based on analysis of the user data using a machine learning (ML) model, wherein the digital user profile record comprises assessment data, and summary data, indicative of user employability potential;
generate an immutable digital employability token based on the digital user profile record, wherein the digital employability token is associated with a unique digital identity identifier; and
output the digital employability token for use by the user based on a minting process.

2. The computing system of claim 1, wherein the digital employability token is a non-fungible token (NFT) associated with a digital authentication certificate.

3. The computing system of claim 2, wherein the NFT is used for trading in a digital labour marketplace, wherein the digital labour marketplace comprises a blockchain network based digital labour marketplace.

4. The computing system of claim 3, wherein the trading comprises execution of a smart contract for an exchange of the NFT between the user and a second user.

5. The computing system of claim 1, wherein the user is one or more of: a graduate, a job seeker, a student, and an employer.

6. The computing system of claim 1, wherein the digital user profile record comprises: a snapshot of the assessment data, and the summary data, wherein the assessment data and the summary data are visualized on one or more dashboards.

7. The computing system of claim 6, wherein the one or more dashboards comprise a visual interface displaying one or more of: higher education outcomes indicators, competencies indicators, employability indicators, world economic forum (WEF) employability skills, skills indicators across different types, job functions predictions, overall employability indicators score, academic qualification data, work exposure data, professional maturity references data, psychometric test results data, profile snapshot, competency requirements, skills requirements, internship experience, top roles, top job functions and desired employability indicators range.

8. A method for generating a digital employability token, the method comprising:
obtaining user data associated with one or more employability intelligence (EI) indicators associated with a user;
generating a digital user profile record based on analysis of the user data using a machine learning (ML) model, wherein the digital user profile record comprises assessment data and summary data, the assessment data and the summary data together being indicative of user employability potential;
generating an immutable digital employability token based on the digital user profile record, wherein the digital employability token is associated with a unique digital identity identifier; and
outputting the digital employability token for use by the user based on a minting process.

9. The method of claim 8, wherein the digital employability token is a non-fungible token (NFT) associated with a digital authentication certificate.

10. The method of claim 9, wherein the NFT is used for trading in a digital labour marketplace, wherein the digital labour marketplace comprises a blockchain network based digital labour marketplace.

11. The method of claim 10, wherein the trading comprises execution of a smart contract for an exchange of the NFT between the user and a second user.

12. The method of claim 8, wherein the user is one or more of: a graduate, a job seeker, a student, and an employer.

13. The method of claim 8, wherein the digital user profile record comprises:
a snapshot of the assessment data and the summary data, wherein the assessment data and the summary data are visualized on one or more dashboards.

14. The method of claim 13, wherein the one or more dashboards comprise a visual interface displaying one or more of: higher education outcomes indicators, competencies indicators, employability indicators, world economic forum (WEF) employability skills, skills indicators across different types, job functions predictions, overall employability indicators score, academic qualification data, work exposure data, professional maturity references data, psychometric test results data, profile snapshot, competency requirements, skills requirements, internship experience, top roles, top job functions and desired employability indicators range.

15. A computer program product comprising a non-transitory computer readable medium having stored thereon computer executable instructions which when executed by at least one processor, cause the at least one processor to conduct operations for:
obtaining user data associated with one or more employability intelligence (EI) indicators associated with a user;
generating a digital user profile record based on analysis of the user data using a machine learning (ML) model, wherein the digital user profile record comprises assessment data, and summary data, indicative of user employability potential;
generating an immutable digital employability token based on the digital user profile record, wherein the digital employability token is associated with a unique digital identity identifier; and
outputting the digital employability token for use by the user based on a minting process.

16. The computer program product of claim 15, wherein the digital employability token is a non-fungible token (NFT) associated with a digital authentication certificate.

17. The computer program product of claim 16, wherein the NFT is used for trading in a digital labour marketplace, wherein the digital labour marketplace comprises a blockchain network based digital labour marketplace.

18. The computer program product of claim 17, wherein the trading comprises execution of a smart contract for an exchange of the NFT between the user and a second user.

19. The computer program product of claim 15, wherein the user is one or more of: a graduate, a job seeker, a student, and an employer.

20. The computer program product of claim 15, wherein the digital user profile record comprises:
a snapshot of the assessment data and the summary data,
wherein the assessment data and the summary data is visualized on one or more dashboard,
wherein the one or more dashboards comprise a visual interface displaying one or more of: higher education outcomes indicators, competencies indicators, employability indicators, world economic forum (WEF) employability skills, skills indicators across different types, job functions predictions, overall employability indicators score, academic qualification data, work exposure data, professional maturity references data, psychometric test results data, profile snapshot, competency requirements, skills requirements, internship experience, top roles, top job functions and desired employability indicators ranges.
